(19) United States
(12) Patent Application Publication
(10) Pub. No.: US 2025/0388437 A1
(43) Pub. Date: Dec. 25, 2025

(54) MOBILE CRANE AND METHOD FOR REDUCING THE LOAD ON THE JIB THEREOF

(71) Applicant: Tadano Demag GmbH, Zweibrücken (DE)

(72) Inventors: Richard Gaal, Saarbrücken (DE); Stefan Diehl, Zweibrücken (DE); Fritz-Botho Köster, Rockenhausen (DE)

(21) Appl. No.: 19/244,285

(22) Filed: Jun. 20, 2025

(30) Foreign Application Priority Data
Jun. 21, 2024 (DE) 102024117649.0

(51) Int. Cl. B66C 23/82; B66C 15/00; B66C 23/36; B66C 23/80

(52) U.S. Cl. CPC B66C 23/82; B66C 15/00; B66C 23/36; B66C 23/80; B66C 2700/0321

(57) ABSTRACT

A mobile crane having a main jib that can be raised and lowered but not telescoped by means of at least one main tensile connector, and a counter jib, where the main tensile connector extends between a first connection point in the region of a head of the main jib and a second connection point in the region of a head of the counter jib, a first secondary tensile connector and a second secondary tensile connector are arranged between the main tensile connector and the main jib, and the first secondary tensile connector has a fixed length. In order to further reduce the loads acting upon the main jib, such as during raising and lowering, and to increase its overall bearing load, at least portions of the second secondary tensile connector can be varied in length.

### CROSS REFERENCE TO RELATED APPLICATION

The present application claims the priority benefits of German patent application no. 102024117649.0, filed on Jun. 21, 2024.

### BACKGROUND AND FIELD OF THE INVENTION

The invention relates to a mobile crane comprising a jib, which can be raised and lowered but not telescoped by means of at least one main tensile connector, and a counter jib, and to a method for reducing the loads on the main jib of such a mobile crane which occur during operation and/or during raising and lowering.

It is generally known that, in the case of cranes having long main jibs, a high bending moment acts upon the main jib when the main jib is being raised from or being lowered to an almost horizontal mounting position. This is worsened by a normal force proportion from the main guying arrangement which extends obliquely with respect to a longitudinal axis of the main jib and is disadvantageously added to the compressive force proportion of the bending moment and increases the sagging of the main jib. In order to reduce this bending moment, additional guying arrangements, also referred to as secondary tensile means, are used between the main guying arrangement and the main jib.

German laid-open document DE 10 2010 022 256 A1 already describes a derrick crane comprising a main jib and a derrick or counter jib. The derrick crane is designed as a crawler crane comprising a pivotable superstructure, on which the main jib and the counter jib are mounted in a luffable manner. The respectively upper ends of the main jib and the counter jib are connected to one another via a main guying arrangement. The main guying arrangement is designed as luffing cabling, which can be varied in length, in order to luff the main jib up, luff it down and to luff it during operation. The luffing cabling is integrated into the main guying arrangement and connects to the counter jib. The length of the luffing cabling can be varied by means of a winch which is arranged on a superstructure of the derrick crane. Moreover, an additional counterweight is suspended from the upper end of the counter jib. In addition to the main guying arrangement, two or three additional guying arrangements are provided, which are each of a fixed length and are arranged outside the luffing cabling at a fixed location on the main guying arrangement and opposite each other in each case at a fixed location on the main jib. Although these additional guying arrangements, which each have a fixed length, are said to be disadvantageous compared to additional guying arrangements having variable lengths in relation to the guying properties, they are said, in turn, to be advantageous by reason of the savings in structural outlay and in weight. The additional guying arrangements should be designed in such a way that the load capacity of the derrick crane is either increased or only slightly reduced when the main jib is positioned steeply. When raising the main jib, it should be adequately supported by the additional guying arrangements.

Furthermore, German utility model DE 202 15 179 U1 describes a crawler crane comprising a main jib and a counter jib which are each designed as a lattice mast jib. A main guying arrangement extends between the upper ends of the main jib and the counter jib and can be adjusted by means of guying cabling. In one embodiment, the guying cable of the guying cabling arrangement extends further in parallel with the main guying arrangement and branches off as an additional guying arrangement to the main jib. The additional guying arrangement is thus designed so as to be variable in length and/or tensile force. Alternatively, two additional guying arrangements which are arranged one behind the other are also described.

U.S. Pat. No. 3,072,265 discloses a further crawler crane comprising a main jib and comprising a guying support instead of a counter jib. In this case also, a main guying arrangement comprising luffing cabling extends between the ends of the main jib and the guying support, and a single additional guying arrangement which can be varied in length is provided. For this purpose, an additional guying cable is guided from a winch on an superstructure of the crawler crane via a deflection pulley on the main guying arrangement to a fixed point on the main jib. German laid-open document DE 36 40 068 A1 describes a comparable single additional guying arrangement which can be varied in length, wherein, however, the additional guying cable is guided from a winch on a superstructure of the crawler crane via a deflection pulley on the main jib to a fixed point on a main guying arrangement. Alternatively, hydraulic cylinders are provided as an additional guying arrangement. A further comparable single additional guying arrangement which can be varied in length is known from German patent document DE 10 2017 117 121 B4. In this document, the winch for the additional guying cable is arranged either on a main jib foot, on a superstructure or on a counter jib.

### SUMMARY OF THE INVENTION

The present invention improves a mobile crane in order to reduce the loads that act upon its non-telescopic main jib, in particular during raising and lowering, and in order to increase its bearing load overall. Furthermore, the invention provides a method for reducing the loads which occur in the main jib during operation and/or during raising and lowering.

In accordance with an embodiment of the invention, in the case of a mobile crane comprising a jib, which can be raised and lowered but not telescoped by means of at least one main tensile connector, and a counter jib, wherein the main tensile connector extends between a first connection point in the region of a head of the jib and a second connection point in the region of a head of the counter jib, a first secondary tensile connector and a second secondary tensile connector are arranged between the main tensile connector and the main jib, and the first secondary tensile connector has a fixed length, a reduction in the loads, which act upon its non-telescopic jib, in particular during raising and lowering is achieved by virtue of the fact that at least portions of the second secondary tensile connector can be varied in length. Overall, this reduction is achieved by the combination of the second secondary tensile connector, which can be varied in length, with the first secondary tensile connector which can be varied in length. This combination is suitable in particular for raising long main jibs having a length of 150 m to 250 m. In an advantageous manner, exactly one single first secondary tensile connector and exactly one single second secondary tensile connector are provided. This allows the guying arrangement of the main jib to be optimized on the one hand for the raising procedure and also for the subsequent operation. In conjunction with the present invention, a secondary tensile connector is to be understood as a secondary tensile connector consisting of a single strand or of a plurality of strands. This plurality of strands mostly extend in parallel and accordingly cannot be seen in a side view.

A tensile force is applied to the main tensile connector for the purpose of raising, lowering and luffing the main jib. The first and second secondary tensile connector counteract the sagging of the main jib, which occurs by reason of its dead weight, in the mounting position and the bending load on the main jib associated therewith. The now variable position and length of the second secondary tensile connector now enable optimum adaptation to the load cases occurring during operation and the raising phase and lowering phase of the main jib. In particular, the critical phase during raising and lowering to a substantially horizontal orientation of the main jib, in which the unsupported length of the main jib is at its greatest, is relieved considerably thereby. As a result, the invention permits easier raising and lowering of long and/or heavy main jibs, wherein further increases can be achieved in particular in the length of the main jib. Moreover, the bearing load for the operation of the mobile crane can also be further increased in this manner. Any losses in bearing load compared to secondary tensile connector with only a fixed length are compensated for. The significant increase in bearing load is achieved by optimization of the guying length of the first secondary tensile connector in the operating state. This optimization of the first secondary tensile connector can be a shortening or a lengthening. It is now also possible to adjust the length of the second secondary tensile connector during mobile crane operation.

In accordance with aspects of the invention, the second secondary tensile connector can be varied in length. This means both the variability of e.g. only portions of its length and also the variation in its length overall. Therefore, the second secondary tensile connector could be configured at least partially e.g. in terms of a pulley block in order to permit length variability in itself.

Provision is made that the second secondary tensile connector can be varied in length during the raising of the main jib, a lowering of the main jib and/or an operation of the main jib.

In relation to the arrangement of the second secondary tensile connector, provision is made that the second secondary tensile connector extends between a sixth connection point on the main jib and a fifth connection point on the main tensile connector. The first secondary tensile connector extends between a fourth connection point on the main jib and a third connection point on the main tensile connector.

Determining the exact position of the fourth and sixth connection point on the main jib is the responsibility of the person skilled in the art who will provide a corresponding specification on the basis of measurements and/or calculations. Despite configurations of the main jibs of mobile cranes which are in part extremely individual, it is to be assumed that typically the sixth connection point will be located centrally between the foot and the head of the main jib. This non-limiting estimation is based upon the assumption that the weight of the jib per meter is substantially constant between its foot and the head, although this is not typically the case because the weight of the main jib decreases towards the head of the main jib. The person skilled in the art will take into consideration any differences in the weight and the resulting normal force curve of the main jib when determining the position of the fourth and sixth connection point in order to achieve the smallest possible loading on the jib, in particular from bending moments.

Provision is also made that the sixth connection point is located in a range between 30% and 60%, preferably between 40% and 60%, of a total length of the main jib as seen in a longitudinal direction of the main jib.

Moreover, provision is made that the fourth connection point is located in a range between 50% and 90%, preferably between 70% and 80%, of a total length of the main jib as seen in a longitudinal direction of the main jib.

In order to vary the length of the second secondary tensile connector and keep it under tension, provision is made that the second secondary tensile connector can be varied in length by means of an adjustment drive.

In structural terms, it is preferred that the adjustment drive consists of one or more hydraulic cylinders or the adjustment drive is an adjustment winch which cooperates with an adjustment reeving arrangement as required.

In a preferred embodiment, the adjustment drive is arranged in the region of a foot of the main jib or in the region of the sixth connection point of the main jib. In conjunction with the present invention, the lower end of the main jib having a length corresponding to 10% of the length of the entire main jib beginning from the foot end is understood as being in the region of the foot of the main jib.

In an advantageous manner, provision is made that the main jib extends without joints between its foot and its head and consists of a plurality of lattice mast portions which are arranged one behind the other. Basically, provision is made that the main jib can be a one-part or multiple-part construction. In a particularly preferred manner, the main jib cannot be telescoped and so it cannot be varied in terms of its length by means of a corresponding drive. Possible changes in its length by the addition or removal of individual portions or segments do not fall within telescoping capability in terms of the invention. For instance, the jib can have an individual and, in this respect, one-piece girder which extends between the foot and the head of the main jib. Alternatively, the main jib can also have at least two girders strung together. The at least one girder can be e.g. a box girder in terms of a hollow body, or can be a lattice girder having a correspondingly open or closed latticework. Moreover, mixed forms and combinations of the foregoing are also feasible.

In a known manner, provision is made that the mobile crane has a superstructure which is arranged so as to be able to rotate on a lower carriage and on which the main jib is supported in a luffable manner via its foot.

For the purpose of raising and lowering the main jib, provision is made that at least portions of the main tensile connector can be varied in length.

Furthermore, the invention is directed to a method, by which the loads on the main jib of an above-described mobile crane which occur during operation and/or during raising and lowering can be reduced, in that a first length of the second secondary tensile connector between the main jib and the main tensile connector in a mounting position of the mobile crane is lengthened to a second length in an operating position of the mobile crane during the course of raising the mobile crane. Of course, in conjunction with the method it is necessary that the length of the second secondary tensile connector is also detected in addition to the adjustment. In addition to the thus possible “holding under tension” of the main tensile connector and the second secondary tensile connector during a change in the orientation of the main jib, said length variability of the second secondary tensile connector offers the option of adapting the sought-after compensation for the sagging caused by means of dead weight and normal force of the jib to changing states. This can be e.g. the orientation of the main jib and the height of the suspended load. By means of a corresponding control, it is then possible to transmit the compensation force, which can be varied for optimum relieving of the load, via the secondary tensile connector in order to advantageously counteract the respective sagging of the jib.

In this case, provision is made in an advantageous manner that the first length is lengthened to the second length if the main jib reaches a luffing angle of greater than or equal to 75 degrees.

It is advantageous that the length of the second secondary tensile connector is varied by means of control which is effected in at least one of the following ways: force-controlled, path-controlled, continuous, constant, linear, stepwise and/or takes into consideration at least one of the following features of the mobile crane: bearing load points, load radius, counterweight radius, bearing load curve.

In other words, the tensile force to be applied to the second secondary tensile connector can be controlled or readjusted, in that e.g. the changing force at the secondary tensile connector is detected from the main jib. Therefore, an increasing force can be compensated for by means of a tensile force counteracting said increasing force, whereas in the event of a decreasing force the tensile force is reduced accordingly. In a similar manner, the movements which result during a change in the force can also be utilised in order to ascertain therefrom and accordingly apply a tensile force level used for compensation purposes. Said control can react linearly to any change with a change in the tensile force or else effect a change in the level of the tensile force to be applied only when the measured parameters move outside a range. Overall, the control can be effected preferably constantly and/or continuously in order to achieve shortest possible reaction times to changing influences.

An exemplified embodiment of the invention will be explained in greater detail with reference to the following description.

### BRIEF DESCRIPTION OF THE DRAWINGS

FIG. 1 shows a side view of a mobile crane in a mounting position;

FIG. 2 shows the mobile crane of FIG. 1 in a raised operating position;

FIG. 3 shows an enlargement of a section of FIG. 1 from the region of a first secondary tensile connector and a second secondary tensile connector in a first embodiment;

FIG. 4 shows an enlargement of a section of FIG. 1 from the region of the second secondary tensile connector in a second embodiment;

FIG. 5 shows an enlargement of a section of FIG. 1 from the region of the second secondary tensile connector in a third embodiment;

FIG. 6 shows an enlargement of a section of FIG. 1 from the region of the second secondary tensile connector in a fourth embodiment;

FIG. 7 shows an enlargement of FIG. 1 from the region of the second secondary tensile connector in a fifth embodiment.

### DESCRIPTION OF THE PREFERRED EMBODIMENTS

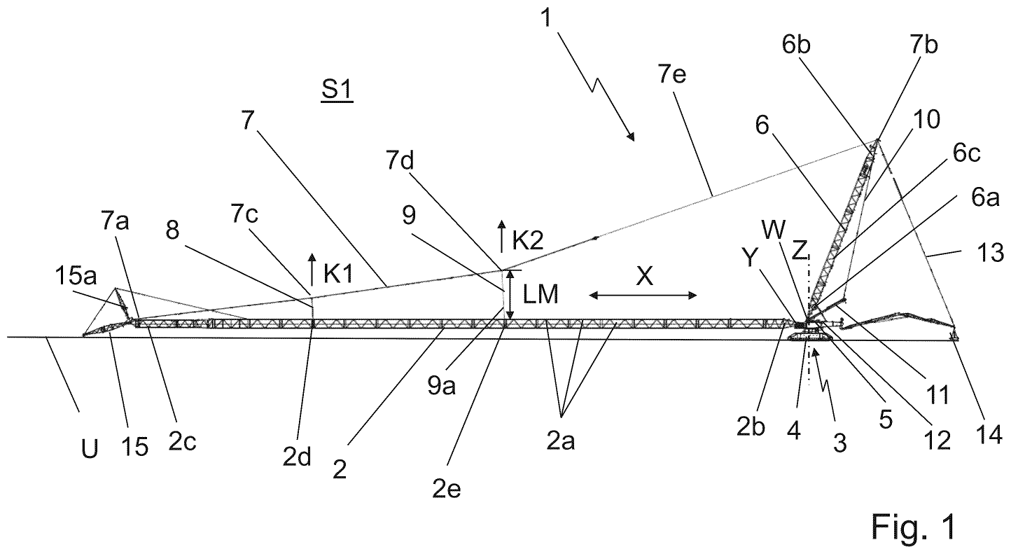

FIG. 1 shows a side view of a mobile crane 1 in accordance with the invention which is standing on a ground U and comprises a long main jib 2 extending in its longitudinal direction X. The main jib 2 of the mobile crane 1 is in its mounting position, in which the main jib 2 extends substantially in parallel with and at a distance from the ground U. The main jib 2 has a length of about 150 m to 250 m and is designed as a jointless latticework or lattice mast girder. This latticework or lattice mast girder cannot be telescoped and thus has a fixed length when it is in a respectively assembled state. In a typical manner, the main jib 2 is constructed from a large number of lattice mast portions 2a which are connected to one another in a bending-resistant manner or are bolted to one another in a detachable manner and are arranged one behind the other. Each lattice mast portion 2a typically consists of a large number of steel profiles which are welded to one another, such as e.g. upper chords, lower chords, transverse beams and diagonal beams, and has a quadrangular or triangular cross-section.

Furthermore, the mobile crane 1 has a lower carriage 3 which has a crawler tracks 4 in the exemplified embodiment shown. Therefore, the mobile crane 1 is a crawler crane. Arranged on the lower carriage 3 is a superstructure 5 which carries the main jib 2 and which can be rotated relative to the lower carriage 3 about a substantially vertical axis Z. The main jib 2 which extends in its longitudinal direction X is supported on the superstructure 5 by means of its foot 2b and, via a horizontal luffing axis Y, is articulated to be luffable in a vertical plane in order to raise, lower or luff the jib 2 during operation. FIG. 1 illustrates the mobile crane 1 in its lowered and substantially horizontal mounting position. Arranged in the region of a head 2c of the main jib 2 opposite the foot 2b is a first connection point 7a which is coupled to a main tensile means 7 that comprises a tensile member or connector or tensioner. The first connection point 7a is therefore located in the region of the head 2c which protrudes from the outermost end of the head 2c up to 2 m, preferably 1 m, in the longitudinal direction X to the foot 2b. Depending upon the configuration, such couplings of the main tensile connector 7 can be a fastening, deflection or a combination thereof. The main tensile connector 7 is coupled oppositely to a head 6b of a counter jib 6 in a second connection point 7b. This counter jib 6 is also referred to as a superlift jib or derrick mast. Therefore, the mobile crane 1 described in this case can also be referred to as a derrick crane or derrick crawler crane. In this case, depending upon the configuration it is also possible for such a coupling of the main tensile connector 7 to be a fastening, deflection or a combination thereof. The counter jib 6 is typically also designed as a lattice mast girder consisting of the previously described lattice mast portions 6c and is mounted on the superstructure 5 so as to be luffable with its foot 6a about a further horizontal luffing axis W.

A further third connection point 7c is arranged on the main tensile connector 7. This third connection point 7c is located between the first connection point 7a and the fifth connection point 7d described below. At this third connection point 7c, a first secondary tensile means 8 comprising a tensile member or connector or tensioner is coupled to the main tensile connector 7, i.e. it is fastened and/or deflected. The main jib 2 is additionally guyed to the main tensile connector 7 with the aid of this first secondary tensile connector 8. For this purpose, the first secondary tensile connector 8 is coupled opposite to the main jib 2 at a fourth connection point 2d, i.e. it is fastened and/or deflected at this location. The coupling range for the fourth connection point 2d is between 50% and 90%, preferably between 70% and 80%, of the length of the main jib 2 as seen in the longitudinal direction X of the main jib 2 and in the direction of its head 2c (the numbers given in % relate to the main jib 2 starting from its lower end of the foot 2b). The first secondary tensile connector 8 also extends approximately at a right angle away from the main jib 2 in the direction of the main tensile connector 7. In this case, the phrase “at a right angle” is intended to include not only a right angle but also an angle range of 80 to 100 degrees, preferably 89 to 91 degrees. Moreover, the first secondary tensile connector 8 has a fixed length. This fixed length is designed in relation to an impending load case of the mobile crane 1 and therefore has been determined and adjusted prior to operation of the mobile crane 1. During operation of the mobile crane 1, the length of the first secondary tensile connector 8 cannot be varied.

This first secondary tensile connector 8 can be designed as a cable consisting of any material, a steel cable, synthetic fiber cable, chain, linkage or as a combination of one, several or all of these elements with each other. Accordingly, the first secondary tensile connector 8 can be formed continuously from only one of these elements or can consist of elements of the same or different types which are arranged one behind the other and are detachably or fixedly connected to one another.

Furthermore, a fifth connection point 7d is arranged on the main tensile connector 7. This fifth connection point 7d is located between the third connection point 7c and the second connection point 7b. At this fifth connection point 7d, a second secondary tensile means 9 comprising a tensile connector or member or tensioner is coupled to the main tensile connector 7, i.e. it is fastened and/or deflected. The main jib 2 is additionally guyed to the main tensile connector 7 with the aid of this second secondary tensile connector 9. For this purpose, the second secondary tensile connector 9 is oppositely coupled to the main tensile connector 7 at a sixth connection point 2e, i.e. it is fastened and/or deflected at this location. Therefore, the second secondary tensile connector 9 extends approximately at a right angle away from the main jib 2 in the direction of the main tensile connector 7. In this case, the phrase “at a right angle” is intended to include not only a right angle but also an angle range of 80 to 100 degrees, preferably 89 to 91 degrees. The coupling range for the sixth connection point 2d is between 30% and 70%, preferably between 40% and 60%, of the length of the main jib 2 as seen in the longitudinal direction X of the main jib 2 and in the direction of its head 2c (the numbers given in % figures relate to the main jib 2 starting from its lower end of the foot 2b). In each case, the fourth connection point 2d is located between the sixth connection point 2e and the head 2c of the main jib 2. Moreover, the second secondary tensile connector 9 has a variable length. This variable length can be varied during the raising of the main jib 2, a lowering of the main jib 2 and/or an operation of the main jib 2.

This second secondary tensile connector 9 can also be designed as a cable consisting of any material, a steel cable, synthetic fiber cable, chain, linkage or as a combination of one, several or all of these elements with each other. Accordingly, the second secondary tensile connector 9 can be formed continuously from only one of these elements or can consist of elements of the same or different types which are arranged one behind the other and are connected detachably or fixedly to one another.

The counter jib 6 is connected via a rearward guying arrangement 10 to the superstructure 5 or a typical further additional jib 11 which is articulated at this location in the region of the luffing axis W and is also referred to as an A-block or support block. This additional jib 11 is supported on the superstructure 5 via further luffing cabling, not illustrated. At its end opposite the main jib 2, the superstructure 5 supports a counterweight 12. Also, an additional counterweight 14 which is also referred to as a superlift is suspended from the head 6b of the counter jib 6 via a suspension 13.

Moreover, an auxiliary jib 15 is additionally arranged on the upper end of the head 2c of the main jib 2. The auxiliary jib 15 can be luffed relative to the main jib 2 and a luffing support 15a is arranged in the region where the auxiliary jib 15 is connected to the main jib 2. Of course, the auxiliary jib 15 can also be rigidly fastened to the main jib 2 at a preselected angle. In essence, the auxiliary jib 15 is optional.

In order to raise the main jib 2 from the horizontal mounting position shown in FIG. 1 in order to luff it during operation and subsequently lower it from the almost vertical operating position into the almost horizontal mounting position, the main tensile connector 7 is designed such that it can be varied in length in relation to the portion between the head 2c of the main jib 2 and the head 6b of the counter jib 6 and in relation to the second secondary tensile connector 9. Typically, pulley block-like reeving arrangements, so-called luffing cabling 7e or adjustment drives 9a, which also include tensioning cabling, are provided for this purpose. In order to lengthen or shorten the luffing cabling 7e or even the tensioning cabling, winches, not illustrated here, are typically provided which are arranged preferably on the superstructure 5 or on the foot 6a of the counter jib 6. In a corresponding manner and depending on the configuration of the luffing cabling 7e or the adjustment drive 9a, the main tensile connector 7 and the second secondary tensile connector 9 are thus each fastened or deflected at their second or fifth connection point 7b, 7d. For the purpose of raising, luffing and lowering, the counter jib 6 is fixed in its operating position at a preselected angle on the superstructure 5 via the guying arrangement 10 and the additional jib 11. The main jib 2 which extends in its substantially horizontal mounting position S1 can be vertically raised, luffed and then lowered by means of a corresponding variation in the length of the main tensile connector 7, in particular the integrated luffing cabling 7e thereof. In parallel with the main tensile connector 7 engaging on the head 2c of the main jib 2, a tensile force in the form of a first compensation force K1 is transmitted to the main jib 2 by the first secondary tensile connector 8 and a tensile force in the form of a second compensation force K2 is transmitted to the main jib 2 by the second secondary tensile connector 9. The two compensation forces K1, K2 serve to reduce or compensate for the loads, in particular bending moments, resulting from the dead weight of the main jib 2 which is otherwise unsupported between the first connection point 7a and its foot 2b. The control required for this purpose can be effected in many ways, including e.g. force-controlled or path-controlled, continuous, constant, linear or else stepwise forms and combinations of one, several or all of the elements thereof. In this case, the control can take into consideration further features, such as e.g. the individual bearing load points and/or bearing load curves of the mobile crane 1 together with the respectively adopted rotation of its superstructure 5 relative to the lower carriage 3.

The first compensation force K1 results from the preselected and fixed length of the first secondary tensile connector 8, the location of the fourth connection point 2d on the main jib 2 and the third connection point 7c on the main tensile connector 7 as well as the tensioning force in the main tensile connector 7.

The same applies to the second compensation force K2, wherein the length LM of the second secondary tensile connector 9 can be varied in the mounting position. The second compensation force K2 is also influenced by the location of the sixth connection point 2e on the main jib 2 and the fifth connection point 7d on the main tensile connector 7 as well as the tensioning force in the main tensile connector 7. The desired length LM of the second secondary tensile connector 9 and thus the desired magnitude of the second compensation force K2 is adjusted preferably via adjustment drives 9a, not illustrated. The hitherto described second secondary tensile connector 9 consists substantially of the adjustment drive 9a, a secondary guying arrangement 9b and any necessary fixed points and deflections. In this case, the secondary guying arrangement 9b is designed as a cable consisting of any material, a steel cable, synthetic fiber cable, chain, linkage or as a combination of one, several or all of these elements with each other. Accordingly, the secondary guying arrangement 9b can be formed continuously from only one of these elements or can consist of elements of the same or different types which are arranged one behind the other and are detachably or fixedly connected to one another. The adjustment drives 9a can be designed as tensioning winches which act upon the secondary guying arrangement 9b directly, via deflections and/or via reeving arrangements. In this case, the tensioning winches are driven electrically or hydraulically. It is also feasible to design the adjustment drives 9a as a hydraulic piston/cylinder unit or tensioning cylinder which in turn act on the secondary guying arrangement 9b directly, via deflections and/or via reeving arrangements. The adjustment drive 9a or the tensioning winch or the tensioning cylinder can be arranged directly on the main jib 2 in the region of the sixth connection point 2e, on the foot 2b of the main jib 2 or on the superstructure 5.

In conjunction with the present invention and with all of the exemplified embodiments, the lower end of the main jib 2 having a length corresponding to 10% of the length of the entire main jib 2 is understood as being in the region of the foot 2b of the main jib 2. In the case of a main jib 2 designed as a lattice mast, the lower end of the main jib 2 thus comprises at least the so-called foot piece, with which the main jib 2 is articulated to the superstructure 5, and, depending upon the length of the foot piece, a so-called first intermediate piece which adjoins thereto and which is then adjoined by the sequence of the further lattice mast portions 2a of the main jib 2.

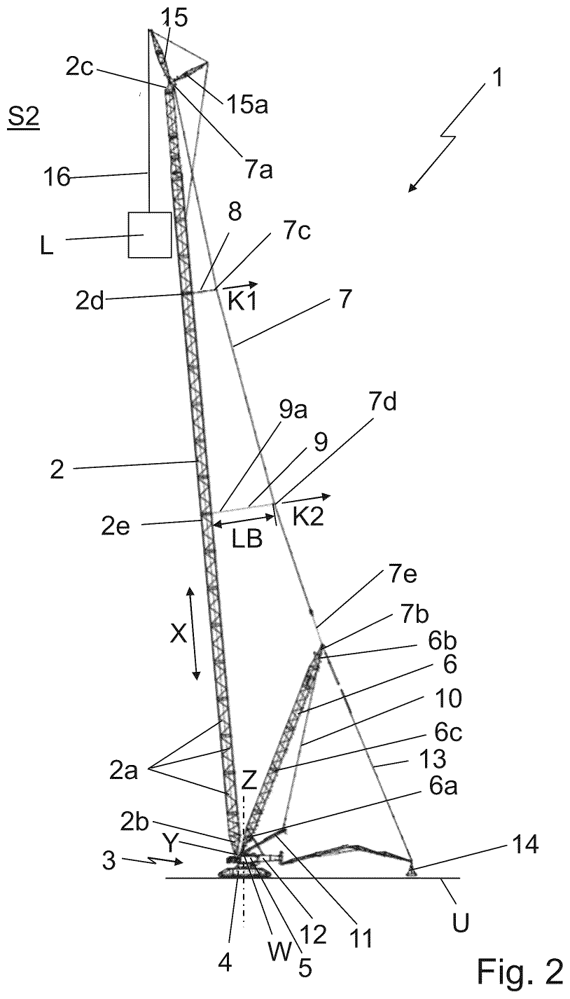

FIG. 2 shows the mobile crane 1 of FIG. 1 with its main jib 2 in a very steep raised operating position for load operation. A load L which is picked up by a lifting cable 16 is also illustrated symbolically. The main jib 2 has been raised from its mounting position to the operating position via the main tensile connector 7, the first secondary tensile connector 8 and the second secondary tensile connector 9 by correspondingly shortening the luffing cabling 7e of the main tensile connector 7. The second secondary tensile connector 9 which can be varied in length has been lengthened from the length LM in the mounting position to a length LB in the operating position during or at the end of the raising procedure. During the course of raising the main jib 2, the bending load on the main jib 2 is reduced because the relative length of the main jib 2 between its foot 2b and head 2c, which extends in parallel with the ground U, is reduced accordingly. Therefore, during the course of raising the main jib 2 the compensation force K2 can also be reduced by lengthening the second secondary tensile connector 9. The second compensation force K2 is now used primarily to increase the bearing load of the mobile crane 1. This lengthening begins when the main jib reaches a luffing angle—starting from a horizontal—of greater than or equal to 75 degrees, i.e. the main jib is positioned steeply. Then, the required adjustment force is minimal. Theoretically, the adjustment can also be effected as soon as the mobile crane 1 has stopped the raising operation and has switched to the load operation.

The lengthening of the second secondary tensile connector 9 significantly increases the bearing load of the mobile crane 1 during load operation because the guying length or length LB of the second secondary tensile connector 9 can be optimally adapted to the respective load case during load operation. Of course, this is accompanied by a determining of the length LM or LB.

In parallel with the second secondary tensile connector 9, the main jib 2 continues to be supported by the first secondary tensile connector 8 with a fixed length.

In order to be able to lower the main jib 2 from the operating position to the mounting position, the second secondary tensile connector 9 must be reduced beforehand to the length LM. The remainder of the procedure is to be performed as described above, but in reverse order.

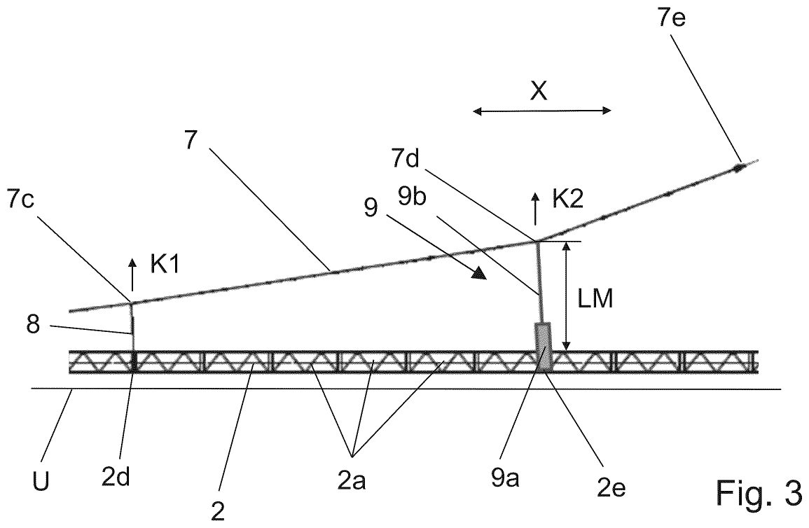

FIG. 3 shows an enlargement of a section of FIG. 1 from the region of the first and second secondary tensile connectors 8, 9, wherein the second secondary tensile connector 9 is formed in a first embodiment. In this embodiment, the adjustment drive 9a is designed as a hydraulic piston/cylinder unit or hydraulic cylinder. The hydraulic cylinder is fastened to the main jib 2 at one end on the housing side and protrudes with its longitudinal extension approximately at a right angle in relation to the longitudinal direction X of the main jib 2 in the direction of the main tensile connector 7. The aforementioned right angle includes not only a right angle but also an angle range of 80 to 100 degrees, preferably 89 to 91 degrees, in relation to the longitudinal direction X. The opposite rod-side end of the hydraulic cylinder is fastened to a secondary guying arrangement 9b of the second secondary tensile connector 9. This secondary guying arrangement 9b is a component of the second secondary tensile connector 9 and is designed as a cable consisting of any material, a steel cable, synthetic fiber cable, chain, linkage or as a combination of one or all of these elements together. Accordingly, the secondary guying arrangement 9b can be formed continuously from only one of these elements or can consist of elements of the same or different types which are arranged one behind the other and are detachably or fixedly connected to one another. This allows the length LM or LB of the secondary tensile connector 9 to be adjusted as required by extending and retracting the hydraulic cylinder.

The secondary guying arrangement 9b of the second secondary tensile connector 9 can consist of three chain portions which are arranged one behind the other. In contrast thereto, the main tensile connector 7 can consist of linkages or rods which are arranged one behind the other. The hydraulic cylinder of the adjustment drive 9a can be fastened on the housing side to cross struts between the lower chords of the main jib 2.

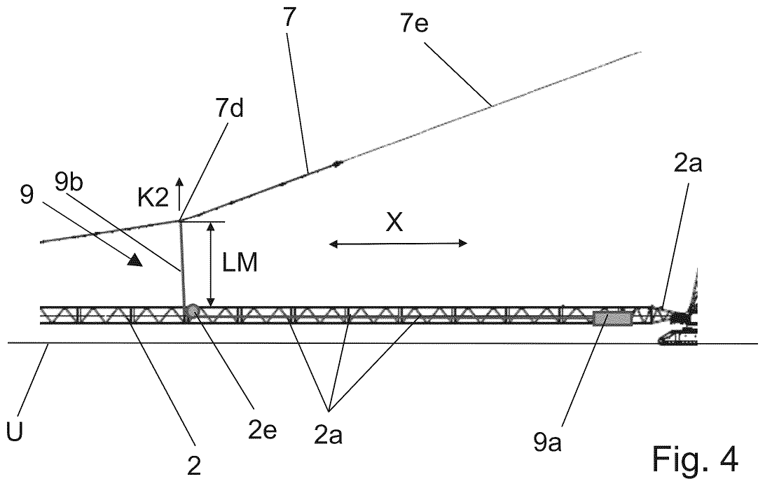

FIG. 4 shows a further enlargement of a section of FIG. 1 from the region of the second secondary tensile connector 9, wherein the second secondary tensile connector 9 is formed in a second embodiment. In this embodiment, the adjustment drive 9a is designed again as a hydraulic piston/cylinder unit or hydraulic cylinder. However, in this case the hydraulic cylinder is fastened to the main jib 2 on the housing side in the region of the foot 2b and extends with its longitudinal extension approximately in parallel with the longitudinal direction X of the main jib 2 in the direction of the head 2c of the main jib 2. The opposite rod-side end of the hydraulic cylinder is fastened to a secondary guying arrangement 9b of the second secondary tensile connector 9. This secondary guying arrangement 9b is a component of the second secondary tensile connector 9 and is designed as a cable or steel cable. Starting from the rod-side end of the hydraulic cylinder, the secondary guying arrangement 9b extends initially in parallel with the longitudinal extension X of the main jib 2, is deflected by approximately 90 degrees in the direction of the main tensile connector 7 at the sixth connection point 2e via a deflection pulley and is fastened at that location to the main tensile connector 7 at the fifth connection point 7d. This allows the length LM or LB of the secondary tensile connector 9 to be adjusted as required by extending and retracting the hydraulic cylinder.

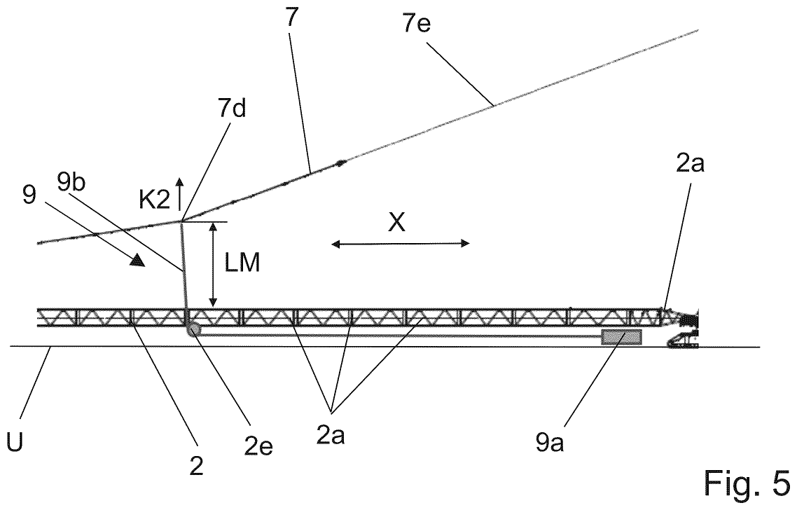

FIG. 5 shows a further enlargement of a section of FIG. 1 from the region of the second secondary tensile connector 9, wherein the second secondary tensile connector 9 is formed in a third embodiment. This third embodiment corresponds substantially to the previously described second embodiment shown in FIG. 4 and so reference is made as far as possible to the description given above. Whereas in the second embodiment, the hydraulic cylinder, the deflection pulley and the secondary guying arrangement 9b extending therebetween are arranged approximately centrally in the main jib 2—in relation to its cross-section—in the third embodiment, the hydraulic cylinder, the deflection pulley and the secondary guying arrangement 9b extending therebetween are arranged below the main jib 2—in relation to its cross-section.

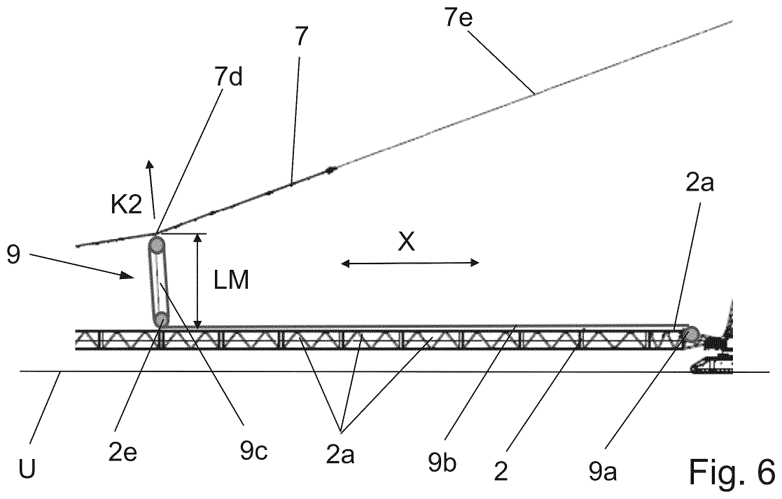

FIG. 6 shows a further enlargement of a section of FIG. 1 from the region of the second secondary tensile connector 9 in a fourth embodiment. In this embodiment, the adjustment drive 9a is designed as a hydraulically or electrically driven adjustment winch. In relation to the aspects common to the first to third embodiments, reference is made to the description given above. The adjustment winch is fasted to the main jib 2 in the region of the foot 2b. The secondary guying arrangement 9b of the second secondary tensile connector 9, which can be wound up and unwound from a winch drum of the adjustment winch, is designed as a cable or steel cable. Starting from the adjustment winch, the secondary guying arrangement 9b extends initially in parallel with the longitudinal extension X of the main jib 2, is deflected at the sixth connection point 2e by approximately 90 degrees in the direction of the main tensile connector 7 via a deflection pulley and at this location is deflected to form an adjustment reeving arrangement 9c between the sixth connection point 2e and the fifth connection point 7d on the main tensile connector 7 via a further deflection pulley and, after one or more reeving arrangements in the fifth connection point 7d, is fastened to the main jib 2 in the sixth connection point 2e. This allows the length LM or LB of the second secondary tensile connector 9 to be adjusted as required by winding up and unwinding the secondary guying arrangement 9b. It is self-evident that the length of the adjustment reeving arrangement 9c can also only have a part of the respectively adjusted length LM or LB.

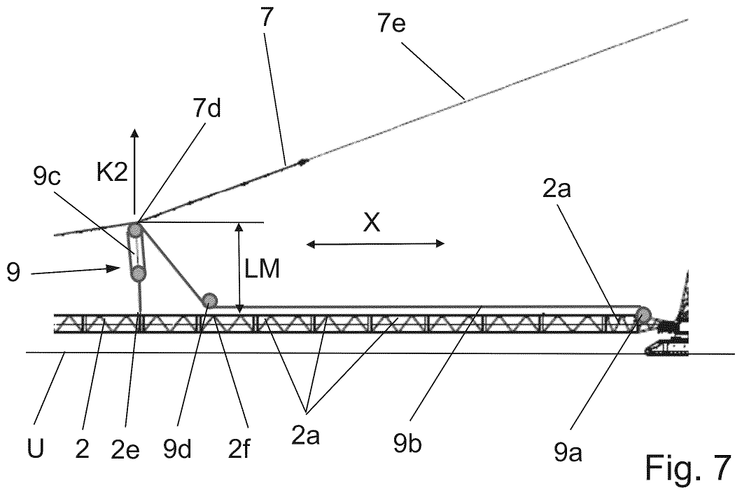

FIG. 7 shows a further enlargement of a section of FIG. 1 from the region of the second secondary tensile connector 9, wherein the second secondary tensile connector 9 is formed in a fifth embodiment. This fifth embodiment corresponds substantially to the previously described fourth embodiment shown in FIG. 6 and so reference is made as far as possible to the description given above. Whereas in the fourth embodiment, the secondary guying arrangement 9b runs from the adjustment winch into the adjustment reeving arrangement 9c via the sixth connection point 2e on the main jib 2, in the fifth embodiment the secondary guying arrangement 9b is guided by the adjustment winch via a seventh connection point 2f with a deflection pulley 9d obliquely upwards and forwards in the direction of the head 2c of the main jib 2 and in the direction of the main tensile connector 7 and runs into the adjustment reeving arrangement 9c at the fifth connection point 7d on the main tensile connector 7. Therefore, the seventh connection point 2f is located in front of the sixth connection point 2e as seen in the direction of the head 2c of the main jib 2. The secondary guying arrangement 9b ends at the fifth connection point 7d on the main tensile connector 7. It is self-evident that the length of the adjustment reeving arrangement 9c can also have the entire length of the respectively adjusted length LM or LB.

In this case, the secondary guying arrangement 9b of the second secondary tensile connector 9 can consist of three chain portions which are arranged one behind the other. In contrast thereto, the main tensile connector 7 can consist of linkages or rods which are arrange one behind the other. The adjustment reeving arrangement 9c can be fastened to the main jib 2 via three chain portions 9e which are arranged one behind the other.

It is also feasible to design the adjustment drive 9a in the form of an electrically or hydraulically driven spindle or an electrically driven linear drive.

Changes and modifications in the specifically described embodiments can be carried out without departing from the principles of the present invention which is intended to be limited only by the scope of the appended claims, as interpreted according to the principles of patent law including the doctrine of equivalents.

1. A mobile crane comprising:
a main jib that can be raised and lowered but not telescoped by means of at least one main tensile connector; and
a counter jib;
wherein the main tensile connector extends between a first connection point in the region of a head of the main jib and a second connection point in the region of a head of the counter jib; and
wherein a first secondary tensile connector and a second secondary tensile connector are arranged between the main tensile connector and the main jib, and the first secondary tensile connector has a fixed length, and wherein at least portions of the second secondary tensile connector can be varied in length.

2. The mobile crane as claimed in claim 1, wherein the second secondary tensile connector can be varied in length during the raising of the main jib, a lowering of the main jib and/or an operation of the main jib.

3. The mobile crane as claimed in claim 1, wherein the second secondary tensile connector extends between a sixth connection point on the main jib and a fifth connection point on the main tensile connector.

4. The mobile crane as claimed in claim 3, wherein the first secondary tensile connector extends between a fourth connection point on the main jib and a third connection point on the main tensile connector.

5. The mobile crane as claimed in claim 4, wherein the sixth connection point is located in a range between 30% and 60% of a total length of the main jib as seen in a longitudinal direction of the main jib.

6. The mobile crane as claimed in claim 5, wherein the fourth connection point is located in a range between 50% and 90% of the total length of the main jib as seen in the longitudinal direction of the main jib.

7. The mobile crane as claimed in claim 1, wherein the second secondary tensile connector can be varied in length by an adjustment drive.

8. The mobile crane as claimed in claim 7, wherein the adjustment drive comprises a hydraulic cylinder.

9. The mobile crane as claimed in claim 7, wherein the adjustment drive comprises an adjustment winch which cooperates with an adjustment reeving arrangement as required.

10. The mobile crane as claimed in claim 7, wherein the adjustment drive is arranged in the region of a foot of the main jib or in the region of a sixth connection point of the main jib.

11. The mobile crane as claimed in claim 1, wherein the main jib extends without joints between a foot of the main jib and the head of the main jib and consists of a plurality of lattice mast portions that are arranged one behind the other.

12. The mobile crane as claimed in claim 1, wherein said crane has a superstructure that is arranged so as to be rotatable on a lower carriage and on which the main jib is supported in a luffable manner via its foot.

13. The mobile crane as claimed in claim 1, wherein at least portions of the main tensile connector can be varied in length.

14. The mobile crane as claimed in claim 2, wherein the second secondary tensile connector extends between a sixth connection point on the main jib and a fifth connection point on the main tensile connector.

15. The mobile crane as claimed in claim 14, wherein the first secondary tensile connector extends between a fourth connection point on the main jib and a third connection point on the main tensile connector.

16. The mobile crane as claimed in claim 15, wherein the fourth connection point is located in a range between 50% and 90% of a total length of the main jib as seen in a longitudinal direction of the main jib.

17. The mobile crane as claimed in claim 14, wherein the sixth connection point is located in a range between 30% and 60% of a total length of the main jib as seen in a longitudinal direction of the main jib.

18. A method for reducing the loads on the main jib of the mobile crane of claim 1 that occur during operation and/or during raising and lowering, comprising lengthening a first length of the second secondary tensile connector between the main jib and the main tensile connector in a mounting position of the mobile crane to a second length in an operating position of the mobile crane during the course of raising the mobile crane.

19. The method as claimed in claim 18, wherein the first length is lengthened to the second length if the main jib reaches a luffing angle of greater than or equal to 75 degrees.

20. The method as claimed in claim 19, wherein the length of the second secondary tensile connector is varied by a control that operates according to at least one of the ways stated hereinafter: force-controlled, path-controlled, continuously, constantly, linearly, stepwise, and/or takes into consideration at least one of the features of the mobile crane stated hereinafter: bearing load points, load radius, counterweight radius, bearing load curve.
